(19) United States
(12) Patent Application Publication
(10) Pub. No.: US 2023/0330948 A1
(43) Pub. Date: Oct. 19, 2023

(54) COMPOSITE BODY MANUFACTURING METHOD, COMPOSITE BODY MANUFACTURING DEVICE, AND COMPOSITE BODY

(71) Applicant: KABUSHIKI KAISHA TOSHIBA, Tokyo (JP)

(72) Inventor: Yuta NAKAMOTO, Yokohama Kanagawa (JP)

(21) Appl. No.: 18/301,000

(22) Filed: Apr. 14, 2023

(30) Foreign Application Priority Data
Apr. 18, 2022 (JP) 2022-068092

(51) Int. Cl. B29C 65/00; B32B 3/30; B32B 15/08; B29C 65/16

(52) U.S. Cl. CPC B29C 66/30223; B32B 3/30; B32B 15/08; B29C 65/16; B29C 66/742; B32B 2250/02; B32B 2307/538

(57) ABSTRACT

A composite body manufacturing method according to an embodiment includes a surface treatment process and a bonding process. In the surface treatment process, surface treatment processing of a first surface of a first member is performed to change an absorptance for the laser light. In the bonding process, the first surface having undergone the surface treatment processing and a second surface of a second member are bonded by irradiating the laser light. The first surface includes a first portion in which an intensity of the laser light irradiated in the bonding process is a first intensity, and a second portion in which the intensity of the laser light irradiated in the bonding process is a second intensity less than the first intensity. The surface treatment processing is performed so that a second absorptance of the second portion becomes greater than a first absorptance of the first portion.

### CROSS-REFERENCE TO RELATED APPLICATIONS

This application is based upon and claims the benefit of priority from Japanese Patent Application No. 2022-068092, filed on Apr. 18, 2022; the entire contents of which are incorporated herein by reference.

### FIELD

Embodiments described herein relate generally to a composite body manufacturing method, a composite body manufacturing device, and a composite body.

### BACKGROUND

There is a method for manufacturing a composite body in which a metal member and a resin member are bonded by irradiating laser light on a bonding surface. The intensity of the laser light is likely to decrease away from the beam center of the laser light. Therefore, the degree of the temperature rise is different between a central portion of the bonding surface proximate to the beam center and an end portion of the bonding surface separated from the beam center, and bonding discrepancies may occur.

### BRIEF DESCRIPTION OF THE DRAWINGS

FIG. 1 is an explanatory drawing schematically illustrating a composite body manufacturing device according to an embodiment;

FIG. 2 is a flowchart illustrating an example of the composite body manufacturing method according to the embodiment;

FIG. 3 is a plan view schematically illustrating an example of the intensity distribution of the laser light in the bonding process of the composite body manufacturing method according to the embodiment;

FIGS. 4A and 4B are a plan view and a cross-sectional view schematically illustrating an example of the first surface having undergone the surface treatment processing of the composite body manufacturing method according to the embodiment;

FIGS. 5A and 5B are a plan view and a cross-sectional view schematically illustrating an example of the first surface having undergone the surface treatment process of the composite body manufacturing method according to the embodiment;

FIGS. 6A and 6B are a plan view and a cross-sectional view schematically illustrating an example of the first surface having undergone the surface treatment process of the composite body manufacturing method according to the embodiment;

FIGS. 7A and 7B are a plan view and a cross-sectional view schematically illustrating an example of the first surface having undergone the surface treatment process of the composite body manufacturing method according to the embodiment;

FIGS. 8A to 8C are graphs illustrating the relationship between the absorptance for the laser light and the temperature of the second member in the laser light irradiation;

FIG. 9 is a perspective view schematically illustrating the composite body according to the embodiment; and

FIGS. 10A to 10C are cross-sectional views schematically illustrating the composite body according to the embodiment.

### DETAILED DESCRIPTION

A composite body manufacturing method according to an embodiment is a method for manufacturing a composite body in which a first member, made of metal, and a second member, made of a resin transmissive to laser light, are bonded; and the method includes a surface treatment process and a bonding process. In the surface treatment process, surface treatment processing of a first surface of the first member is performed to change an absorptance for the laser light. In the bonding process, the first surface having undergone the surface treatment processing and a second surface of the second member are bonded by irradiating the laser light, without scanning, toward the first surface from a surface of the second member at a side opposite to the second surface in a state in which the first surface is caused to contact the second surface. The first surface includes a first portion in which an intensity of the laser light irradiated in the bonding process is a first intensity, and a second portion in which the intensity of the laser light irradiated in the bonding process is a second intensity less than the first intensity. In the surface treatment process, the surface treatment processing is performed so that a second absorptance, i.e., an absorptance of the second portion for the laser light, becomes greater than a first absorptance, i.e., an absorptance of the first portion for the laser light.

Exemplary embodiments will now be described with reference to the drawings.

The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

In the specification of the application and the drawings, components similar to those described in regard to a drawing thereinabove are marked with like reference numerals; and a detailed description is omitted as appropriate.

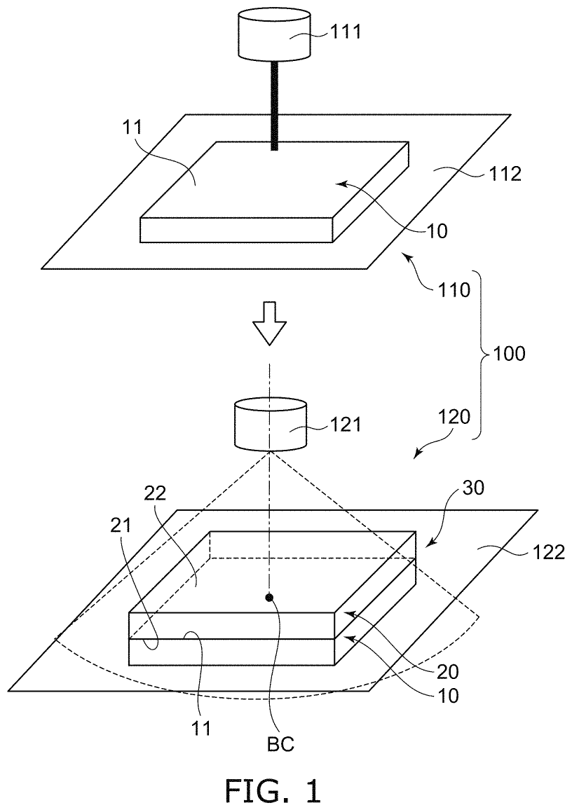

FIG. 1 is an explanatory drawing schematically illustrating a composite body manufacturing device according to an embodiment.

The composite body manufacturing device 100 according to the embodiment is a device that manufactures a composite body 30 in which a first member 10 and a second member 20 are bonded.

The first member 10 is made of metal. The first member 10 includes, for example, at least one of iron or copper. The second member 20 is made of resin. For example, the second member 20 is made of a resin transmissive to laser light. For example, the second member 20 is made of a resin transmissive to laser light of a wavelength of not less than 800 nm and not more than 2000 nm. The second member 20 includes, for example, at least one of an epoxy resin or an acrylic resin.

As illustrated in FIG. 1, the composite body manufacturing device 100 according to the embodiment includes a surface treatment part 110 and a bonding part 120.

The surface treatment part 110 performs surface treatment processing to change the absorptance for the laser light of a first surface 11 of the first member 10. The surface treatment part 110 includes, for example, a first laser irradiation part 111 and a first placement part 112. For example, the surface treatment part 110 performs surface treatment processing by irradiating the laser light from the first laser irradiation part 111 onto the first surface 11 of the first member 10 placed on the first placement part 112.

The first laser irradiation part 111 includes, for example, a pulsed laser producing a pulsed output at a constant repetition frequency (pulse width). When the first laser irradiation part 111 includes a pulsed laser, the pulse width of the pulsed laser light is, for example, not more than a nanosecond. When the first laser irradiation part 111 includes a pulsed laser, the wavelength of the pulsed laser light is, for example, not less than 300 nm and not more than 1000 nm. The surface treatment processing is not limited to the irradiation of pulsed laser light. The surface treatment processing is described below.

The bonding part 120 bonds the first surface 11 of the first member 10 having undergone the surface treatment processing and a second surface 21 of the second member 20. The bonding part 120 includes, for example, a second laser irradiation part 121 and a second placement part 122. The bonding part 120 bonds the first surface 11 and the second surface 21 by irradiating the laser light from the second laser irradiation part 121 toward the first surface 11 of the first member 10 in a state in which the first surface 11 of the first member 10 placed on the second placement part 122 is caused to contact the second surface 21 of the second member 20.

At this time, the second laser irradiation part 121 irradiates the laser light toward a surface 22 of the second member 20 at the side opposite to the second surface 21. The laser light that is irradiated on the surface 22 of the second member 20 passes through the interior of the second member 20 and is irradiated on the first surface 11 of the first member 10. When the laser light is irradiated on the first surface 11, the first surface 11 is heated by the laser light; the second surface 21 of the second member 20 contacting the first surface 11 is melted; and the first surface 11 and the second surface 21 are bonded. The second laser irradiation part 121 irradiates the laser light without scanning.

The second laser irradiation part 121 includes, for example, a continuous wave (CW) laser that continuously produces a constant output. The second laser irradiation part 121 may include a pulsed laser. The wavelength of the laser light irradiated from the second laser irradiation part 121 is selected based on the absorption wavelength of the first member 10. When the first member 10 includes iron, the wavelength of the laser light irradiated from the second laser irradiation part 121 is, for example, not less than 800 nm and not more than 2000 nm. When the first member 10 includes copper, the wavelength of the laser light irradiated from the second laser irradiation part 121 is, for example, not less than 500 nm and not more than 2000 nm.

A composite body manufacturing method that uses the composite body manufacturing device 100 according to the embodiment will now be described.

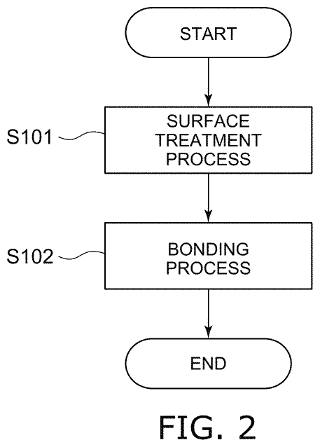

FIG. 2 is a flowchart illustrating an example of the composite body manufacturing method according to the embodiment.

As illustrated in FIG. 2, the composite body manufacturing method according to the embodiment includes a surface treatment process and a bonding process.

In the composite body manufacturing method according to the embodiment, first, a surface treatment process is performed by the surface treatment part 110 described above (step S101). In the surface treatment process, surface treatment processing of the first surface 11 of the first member 10 is performed to change the absorptance for the laser light. The surface treatment process is described below.

Next, in the composite body manufacturing method according to the embodiment, a bonding process is performed by the bonding part 120 described above (step S102). In the bonding process, the first surface 11 of the first member 10 having undergone the surface treatment processing and the second surface 21 of the second member 20 are bonded. In the bonding process, the first surface 11 and the second surface 21 are bonded by irradiating laser light, without scanning, toward the first surface 11 of the first member 10 from the surface 22 of the second member 20 at the side opposite to the second surface 21 in a state in which the first surface 11 is caused to contact the second surface 21.

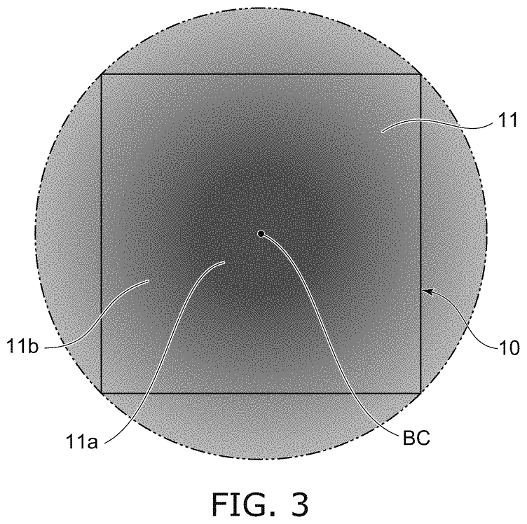

FIG. 3 is a plan view schematically illustrating an example of the intensity distribution of the laser light in the bonding process of the composite body manufacturing method according to the embodiment.

In FIG. 3, portions of high laser light intensity are shown in darker colors, and portions of low laser light intensity are shown in lighter colors.

As described above, in the bonding process, the laser light is irradiated on the entire portion to be bonded without scanning. The intensity of the laser light is likely to decrease away from a beam center BC of the laser light. Therefore, as illustrated in FIG. 3, an intensity difference of the irradiated laser light easily occurs between a first portion 11a (the central portion) of the first surface 11 proximate to the beam center BC and a second portion 11b (the end portion) of the first surface 11 separated from the beam center BC.

The first surface 11 includes the first portion 11a and the second portion 11b. A second intensity, i.e., the intensity of the laser light irradiated on the second portion 11b in the bonding process, is less than a first intensity, i.e., the intensity of the laser light irradiated on the first portion 11a in the bonding process.

Compared to the first portion 11a in which the intensity of the laser light irradiated in the bonding process is high, the first member 10 is not easily heated in the second portion 11b in which the intensity of the laser light irradiated in the bonding process is low. Therefore, compared to the section of the second member 20 contacting the first portion 11a, the resin melts less easily at the section of the second member 20 contacting the second portion 11b, and as a result, is likely to have a lower bonding strength.

Therefore, in the surface treatment process of the composite body manufacturing method according to the embodiment, the surface treatment processing is performed so that the absorptance of the second portion 11b for the laser light becomes greater than the absorptance of the first portion 11a for the laser light. Here, “laser light” is the laser light irradiated in the bonding process. Hereinbelow, the absorptance of the first portion 11a for the laser light is called the “first absorptance”, and the absorptance of the second portion 11b for the laser light is called the “second absorptance”.

Thus, by performing the surface treatment processing so that the second absorptance becomes greater than the first absorptance, the temperature difference between the second portion 11b and the first portion 11a can be suppressed even when the intensity of the laser light irradiated on the second portion 11b is less than the intensity of the laser light irradiated on the first portion 11a. Accordingly, the temperature can be made more uniform in the plane of the first surface 11 in the bonding process, and fluctuation of the bonding strength in the plane of the first surface 11 can be suppressed. Accordingly, bonding discrepancies can be suppressed even when the intensity of the irradiated laser light is nonuniform in the bonding surface (the first surface 11).

In the surface treatment process, for example, the second absorptance is made greater than the first absorptance by performing surface treatment processing of the second portion 11b to increase absorptance for the laser light. Or, in the surface treatment process, for example, the second absorptance is made greater than the first absorptance by performing surface treatment processing of both the first and second portions 11a and 11b to increase absorptance for the laser light, and by setting the degree of processing of the second portion 11b to be greater than the degree of processing of the first portion 11a.

For example, a method that increases the surface roughness of the target portion is an example of a method that increases the absorptance for the laser light. Specifically, a method that irradiates a pulsed laser light on the target portion is an example of such a method. Other methods that increase absorptance for the laser light may include physical methods of rubbing the target portion with a file or the like, chemical methods of applying a chemical or the like to the target portion, etc.

In the surface treatment process, for example, the second absorptance may be made greater than the first absorptance by performing surface treatment processing of the first portion 11a to reduce the absorptance for the laser light. Or, in the surface treatment process, for example, the second absorptance may be made greater than the first absorptance by performing surface treatment processing of both the first and second portions 11a and 11b to reduce the absorptance for the laser light, and by setting the degree of processing in the first portion 11a to be greater than the degree of processing in the second portion 11b.

For example, a method that increases the laser reflectance of the target portion is an example of a method that reduces the absorptance for the laser light. Specifically, methods that melt the surface by irradiating laser light on the target portion, etc., are examples of such a method.

For example, compared to a method that reduces the absorptance for the laser light, the second absorptance can easily be made greater than the first absorptance by using a method that increases the absorptance for the laser light. Compared to other methods, a method that increases the absorptance for the laser light by irradiating pulsed laser light easily performs the surface treatment processing in the desired area with the desired degree of processing. Also, compared to other methods, a method that increases the absorptance for the laser light by irradiating pulsed laser light easily performs surface treatment processing such as when the absorptance for the laser light is continuously increased from the first portion 11a toward the second portion 11b.

For example, the difference between the first absorptance and the second absorptance is determined based on the intensity distribution in the first surface 11 of the laser light irradiated in the bonding process. For example, it is favorable for the difference between the first absorptance and the second absorptance to be large when the difference is large between the intensity of the laser light at a position (the first portion 11a) proximate to the beam center BC of the laser light and the intensity of the laser light at a position (the second portion 11b) separated from the beam center BC of the laser light. On the other hand, it is favorable for the difference between the first absorptance and the second absorptance to be small when the difference is small between the intensity of the laser light at the position (the first portion 11a) proximate to the beam center BC of the laser light and the intensity of the laser light at the position (the second portion 11b) separated from the beam center BC of the laser light.

Examples of the surface treatment processing will now be described.

Examples will now be described in which the surface treatment processing is performed to increase the absorptance for the laser light of the second portion 11b, or of both the first and second portions 11a and 11b.

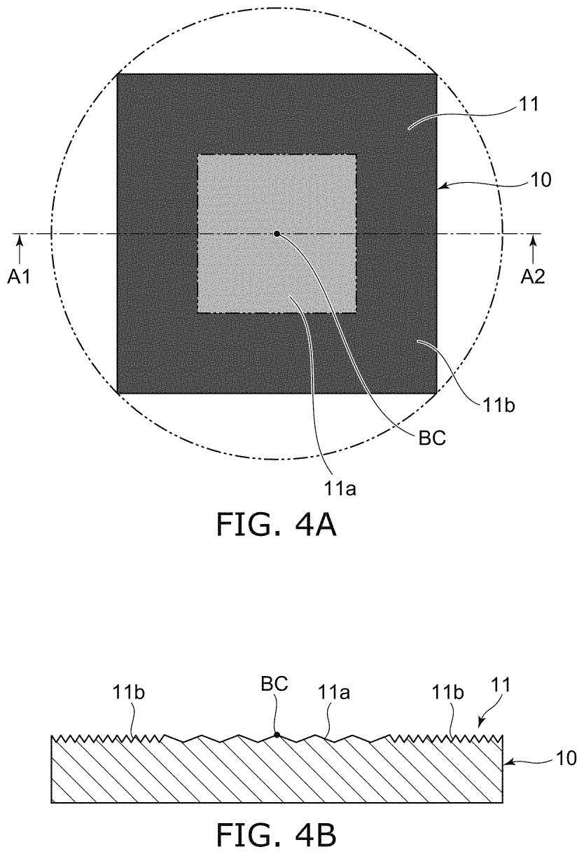

FIGS. 4A and 4B are a plan view and a cross-sectional view schematically illustrating an example of the first surface having undergone the surface treatment processing of the composite body manufacturing method according to the embodiment.

FIG. 4B is a cross-sectional view along line A1-A2 shown in FIG. 4A.

In the example as illustrated in FIGS. 4A and 4B, the surface treatment processing is performed on both the first and second portions 11a and 11b; and the second absorptance is made greater than the first absorptance by setting the degree of processing in the second portion 11b to be greater than the degree of processing in the first portion 11a. The surface roughness of the second portion 11b is greater than the surface roughness of the first portion 11a.

For example, the surface roughness is represented by the nanostructure grain size or nanostructure density formed by the surface treatment processing. The grain size of the nanostructure in the second portion 11b is, for example, less than the grain size of the nanostructure in the first portion 11a. The density of the nanostructure in the second portion 11b is, for example, greater than a density of the nanostructure in the first portion 11a.

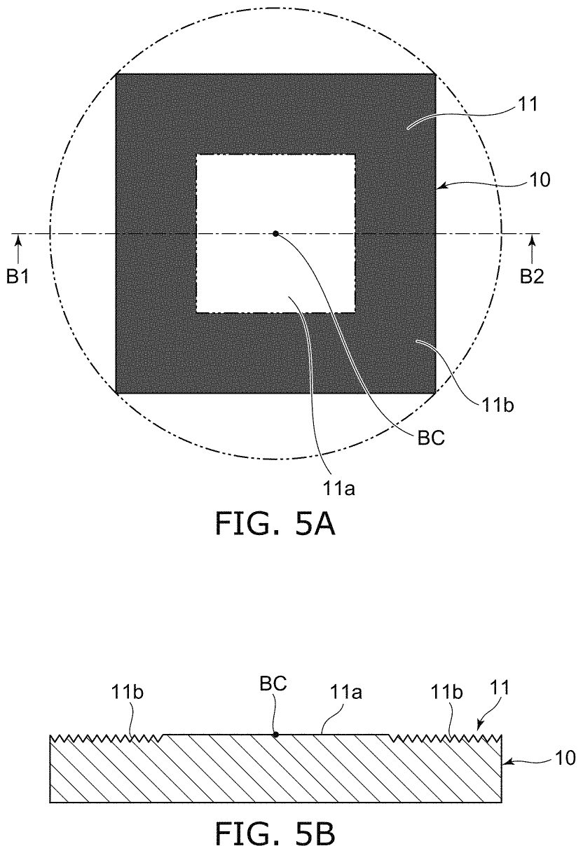

FIGS. 5A and 5B are a plan view and a cross-sectional view schematically illustrating an example of the first surface having undergone the surface treatment process of the composite body manufacturing method according to the embodiment.

FIG. 5B is a cross-sectional view along line B1-B2 shown in FIG. 5A.

In the example as illustrated in FIGS. 5A and 5B, the second absorptance is made greater than the first absorptance by performing surface treatment processing of the second portion 11b to increase absorptance for the laser light without performing the surface treatment processing of the first portion 11a. The surface roughness of the second portion 11b is greater than the surface roughness of the first portion 11a.

For example, a processing condition of the surface treatment process is determined based on at least one of the thermal conductivity of the first member 10, the absorptance for the laser light of the first surface 11, or the melting temperature of the second member 20. Here, “processing condition” includes, for example, whether or not surface treatment processing is performed on the first portion 11a, the degrees (the degrees of processing) of the surface treatment processing performed on the first and second portions 11a and 11b, etc.

For example, it is favorable to perform the surface treatment processing of the first portion 11a when the thermal conductivity of the first member 10 is large, when the absorptance for the laser light of the first surface 11 before the surface treatment processing is small, when the melting temperature of the second member 20 is high, etc. In such cases, it is favorable to increase the degrees of the surface treatment processing of the first and second portions 11a and 11b.

On the other hand, for example, surface treatment processing may not be performed on the first portion 11a when the thermal conductivity of the first member 10 is small, when the absorptance for the laser light of the first surface 11 before the surface treatment processing is large, when the melting temperature of the second member 20 is low, etc. In such cases, it is favorable to reduce the degree of the surface treatment processing of the second portion 11b.

To make the degree of the temperature rise uniform in the bonding surface, for example, a method may be considered in which the intensity distribution of the laser light irradiated from the second laser irradiation part 121 is made uniform. However, in such a method, it is difficult to select the appropriate conditions according to the types of the first and second members 10 and 20, the type of laser used in the surface treatment processing, the type of laser used in the bonding, etc.

In contrast, according to a method such as that of the embodiment in which the absorptances of the laser light are set to be different in the plane of the first surface 11 by using surface treatment processing, the appropriate conditions can be selected according to the types of the first and second members 10 and 20, the type of laser used in the surface treatment processing, the type of laser used in the bonding, etc. Accordingly, bonding discrepancies can be more reliably suppressed even when the intensity of the irradiated laser light is nonuniform in the bonding surface (the first surface 11).

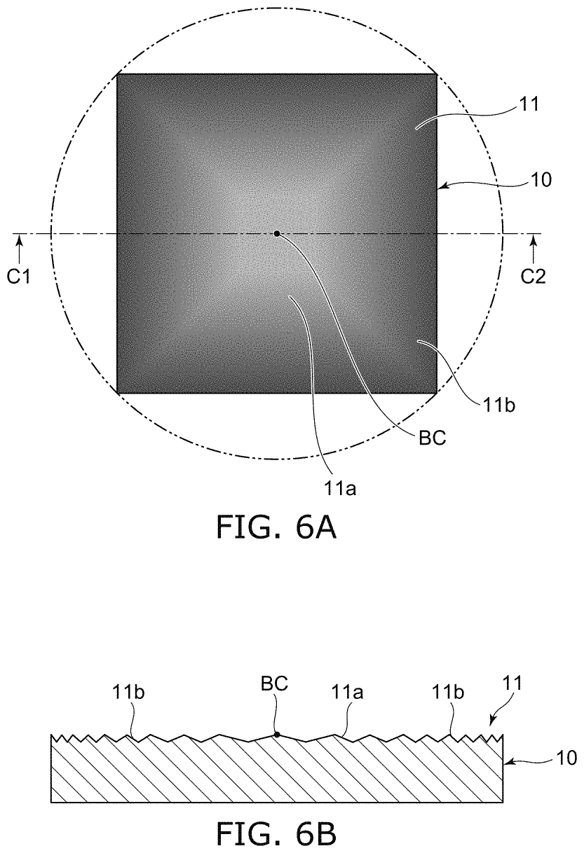

FIGS. 6A and 6B are a plan view and a cross-sectional view schematically illustrating an example of the first surface having undergone the surface treatment process of the composite body manufacturing method according to the embodiment.

FIG. 6B is a cross-sectional view along line C1-C2 shown in FIG. 6A.

In the example as illustrated in FIGS. 6A and 6B, surface treatment processing is performed so that the absorptance for the laser light continuously increases from the first portion 11a toward the second portion 11b. That is, the absorptance for the laser light gradually increases from the first portion 11a toward the second portion 11b. The surface roughness of the first surface 11 continuously increases from the first portion 11a toward the second portion 11b (i.e., from the center toward the end portion).

For example, the surface treatment can be performed to cause the surface roughness to continuously increase from the first portion 11a toward the second portion 11b by changing the irradiation time and/or intensity of the pulsed laser light while scanning from the center of the first portion 11a toward the end portion of the first surface 11.

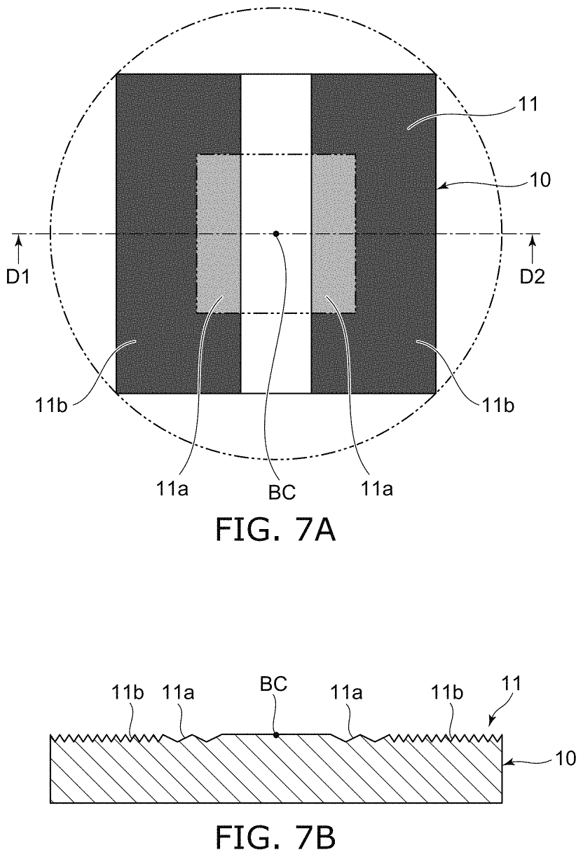

FIGS. 7A and 7B are a plan view and a cross-sectional view schematically illustrating an example of the first surface having undergone the surface treatment process of the composite body manufacturing method according to the embodiment.

FIG. 7B is a cross-sectional view along line D1-D2 shown in FIG. 7A.

In the example as illustrated in FIGS. 7A and 7B, surface treatment processing is not performed for portions of the first and second portions 11a and 11b. Thus, surface treatment processing may not be performed on a portion of the first surface 11 that is not bonded with the second member 20. The first portion 11a and the second portion 11b may include multiple portions having different absorptances of the laser light.

The absorptance for the laser light of the portion at which surface treatment processing is not performed is, for example, less than the first absorptance. In such a case, the absorptance for the laser light of the portion of the first portion 11a in which surface treatment processing is performed is considered to be the first absorptance; and the absorptance for the laser light of the portion of the second portion 11b in which surface treatment processing is performed is considered to be the second absorptance.

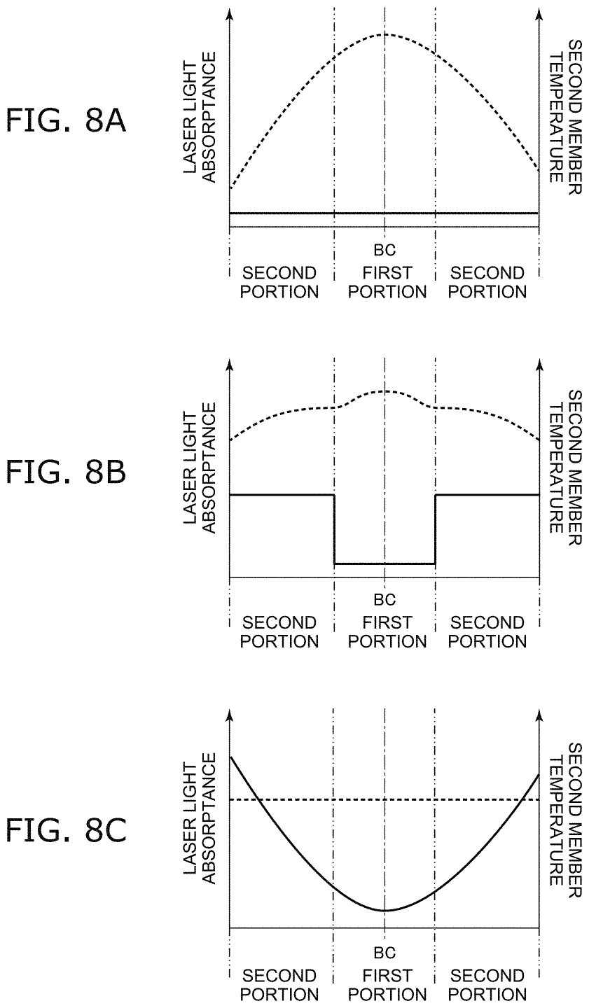

FIGS. 8A to 8C are graphs illustrating the relationship between the absorptance for the laser light and the temperature of the second member in the laser light irradiation.

In FIGS. 8A to 8C, the distribution of the absorptance for the laser light of the first surface 11 of the first member 10 is illustrated by a solid line, and the distribution of the temperature at a position corresponding to the second member 20 when the laser light is irradiated in the bonding process is illustrated by a broken line. The beam center of the laser light is illustrated by a single dot-dash line.

As illustrated in FIG. 8A, when the absorptance (the second absorptance) for the laser light of the second portion 11b is equal to the absorptance (the first absorptance) for the laser light of the first portion 11a, the temperature of the section of the second member 20 contacting the second portion 11b is less than the temperature of the section of the second member 20 contacting the first portion 11a when the laser light is irradiated in the bonding process. The difference between the temperature of the section of the second member 20 contacting the second portion 11b and the temperature of the section of the second member 20 contacting the first portion 11a easily becomes large. That is, the temperature of the second member 20 tends to become nonuniform in the plane when surface treatment processing is not performed on the first surface 11 or when surface treatment processing is uniformly performed over the entire surface of the first surface 11.

In contrast, as illustrated in FIGS. 8B and 8C, compared to when the absorptance (the second absorptance) for the laser light of the second portion 11b is equal to the absorptance (the first absorptance) for the laser light of the first portion 11a, the difference between the temperature of the section of the second member 20 contacting the second portion 11b and the temperature of the section of the second member 20 contacting the first portion 11a is easily reduced by performing surface treatment processing so that the absorptance (the second absorptance) for the laser light of the second portion 11b becomes greater than the absorptance (the first absorptance) for the laser light of the first portion 11a. That is, the temperature of the second member 20 is easily made uniform in the plane.

As illustrated in FIG. 8C, the temperature of the second member 20 is easily made more uniform in the plane by performing surface treatment to continuously increase the surface roughness from the first portion 11a toward the second portion 11b.

Although the first surface 11 includes the first portion 11a and the second portion 11b in the example above, the first surface 11 may further include a third portion positioned radially outward of the second portion 11b. For example, the third portion surrounds the outer side of the second portion 11b. In such a case, the absorptance (a third absorptance) for the laser light of the third portion is, for example, greater than the absorptance (the second absorptance) for the laser light of the second portion 11b. In such a case, the surface roughness of the third portion is, for example, greater than the surface roughness of the second portion 11b. The surface roughness of the third portion is, for example, constant in the third portion. The absorptance for the laser light of the first surface 11 may continuously increase from the second portion 11b toward the third portion (i.e., from the center toward the end portion). The surface roughness of the first surface 11 may continuously increase from the second portion 11b toward the third portion (i.e., from the center toward the end portion). The third portion may include multiple portions having different surface roughnesses. The first surface 11 may include one or more portions positioned radially outward of the third portion.

The composite body 30 manufactured by the composite body manufacturing device 100 according to the embodiment and the composite body manufacturing method according to the embodiment will now be described.

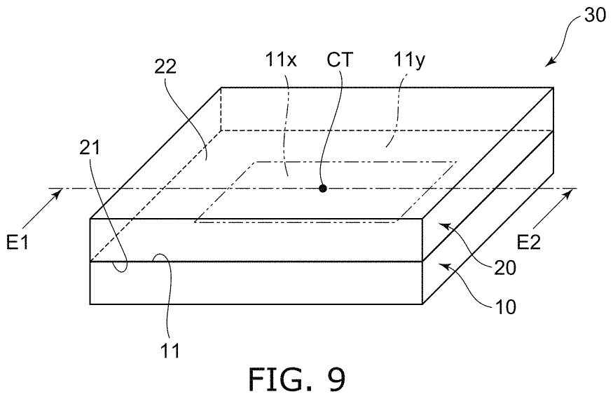

FIG. 9 is a perspective view schematically illustrating the composite body according to the embodiment.

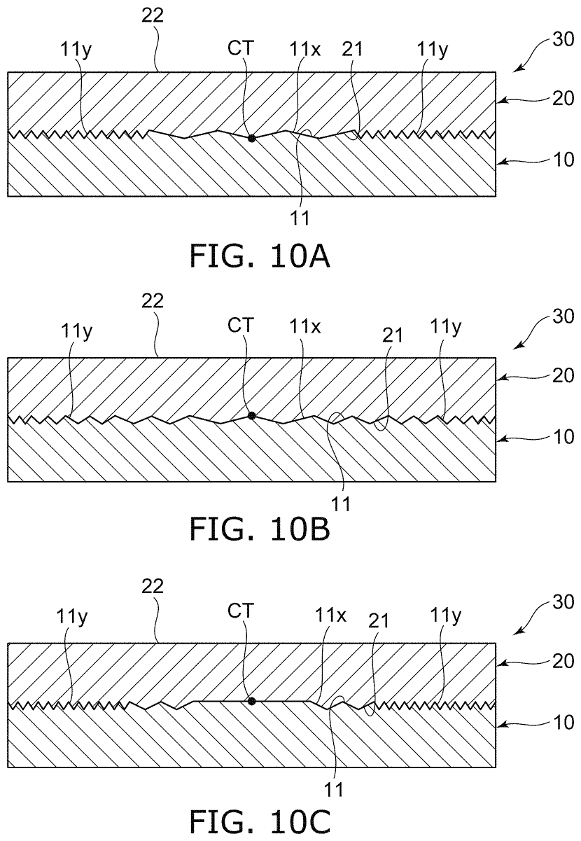

FIGS. 10A to 10C are cross-sectional views schematically illustrating the composite body according to the embodiment.

FIGS. 10A to 10C are examples of cross-sectional views along line E1-E2 shown in FIG. 9.

As illustrated in FIG. 9 and FIGS. 10A to 10C, the composite body 30 according to the embodiment includes the first member 10 and the second member 20. The first member 10 and the second member 20 are bonded via the first and second surfaces 11 and 21.

The first surface 11 includes a first region 11x and a second region 11y. The first region 11x corresponds to the first portion 11a after bonding. The second region 11y corresponds to the second portion 11b after bonding. The first region 11x includes, for example, a center CT of the first surface 11. For example, the second region 11y is positioned radially outward of the first region 11x. For example, the second region 11y surrounds the outer side of the first region 11x.

The surface roughness of at least a portion of the second region 11y is greater than the surface roughness of at least a portion of the first region 11x. The surface roughness of the entire second region 11y is, for example, greater than the surface roughness of the entire first region 11x. The average value of the surface roughness of the second region 11y is, for example, greater than the average value of the surface roughness of the first region 11x.

As illustrated in FIG. 10A, the surface roughness of the first region 11x is, for example, constant in the first region 11x. Also, for example, the surface roughness of the second region 11y is constant inside the second region 11y. That is, the first surface 11 includes, for example, multiple regions of different surface roughnesses. For example, the composite body 30 that has a structure such as that shown in FIG. 10A can be manufactured by performing surface treatment processing such as that shown in FIGS. 4A and 4B or surface treatment processing such as that shown in FIGS. 5A and 5B.

As illustrated in FIG. 10B, for example, the surface roughness of the first surface 11 may continuously increase from the first region 11x toward the second region 11y. In such a case, for example, the surface roughness of the first region 11x is not constant in the first region 11x. In such a case, for example, the surface roughness of the second region 11y is not constant in the second region 11y. For example, the composite body 30 that has a structure such as that shown in FIG. 10B can be manufactured by performing surface treatment processing such as that shown in FIGS. 6A and 6B.

As illustrated in FIG. 10C, for example, the surface roughness of the first region 11x may not be constant in the first region 11x. That is, the first region 11x may include multiple regions of different surface roughnesses. Although the surface roughness of the second region 11y is constant in the second region 11y in the example, the surface roughness of the second region 11y may not be constant in the second region 11y. That is, the second region 11y may include multiple regions of different surface roughnesses. For example, the composite body 30 that has a structure such as that shown in FIG. 10C can be manufactured by performing surface treatment processing such as that shown in FIG. 7A.

For example, the surface roughness of the first surface 11 is represented by the pitch (width), density, depth, etc., of the unevenness of the first surface 11 in the cross section of the composite body 30 of FIG. 7B. The pitch (the width) of the unevenness in the second region 11y is, for example, less than the pitch (the width) of the unevenness in the first region 11x. The density of the unevenness in the second region 11y is, for example, greater than a density of the unevenness in the first region 11x. The depth of the unevenness in the second region 11y is, for example, greater than the depth of the unevenness in the first region 11x.

Thus, the bonding discrepancies between the first member 10 and the second member 20 are suppressed in the composite body 30 if the surface roughness of the second region 11y is greater than the surface roughness of the first region 11x.

Although the first surface 11 includes the first region 11x and the second region 11y in the example above, the first surface 11 may further include a third region positioned radially outward of the second region 11y. For example, the third region surrounds the outer side of the second region 11y. The third region corresponds to the third portion after bonding. In such a case, the surface roughness of the third region is, for example, greater than the surface roughness of the second region 11y. The surface roughness of the third region is, for example, constant in the third region. The surface roughness of the first surface 11 may continuously increase from the second region 11y toward the third region (i.e., from the center toward the end portion). Also, the third region may include multiple regions of different surface roughnesses. The first surface 11 may include one or more regions positioned radially outward of the third region.

Although examples are described above in which the beam center BC of the laser light irradiated in the bonding process and the center CT of the first member 10 are aligned, the beam center BC and the center CT of the first member 10 may not be aligned.

Embodiments may include the following configurations.

### (Configuration 1)

A composite body manufacturing method for manufacturing a composite body in which a first member and a second member are bonded, the first member being made of metal, the second member being made of a resin transmissive to a laser light, the method comprising:
a surface treatment process of performing a surface treatment processing of a first surface of the first member to change an absorptance for the laser light; and
a bonding process of bonding the first surface having undergone the surface treatment processing and a second surface of the second member by irradiating the laser light, without scanning, toward the first surface from a surface of the second member at a side opposite to the second surface in a state in which the first surface is caused to contact the second surface,
the first surface including
   a first portion in which an intensity of the laser light irradiated in the bonding process is a first intensity, and
   a second portion in which the intensity of the laser light irradiated in the bonding process is a second intensity, the second intensity being less than the first intensity,
in the surface treatment process, the surface treatment processing being performed so that a second absorptance becomes greater than a first absorptance,
the second absorptance being an absorptance of the second portion for the laser light,
the first absorptance being an absorptance of the first portion for the laser light.

### (Configuration 2)

The method according to configuration 1, wherein

in the surface treatment process, the absorptance of the second portion for the laser light is increased by irradiating a pulsed laser light on the second portion.

### (Configuration 3)

The method according to configuration 1 or 2, wherein

in the surface treatment process, the surface treatment processing is performed so that the absorptance for the laser light continuously increases from the first portion toward the second portion.

### (Configuration 4)

The method according to any one of configurations 1 to 3, wherein

in the surface treatment process, a difference between the first absorptance and the second absorptance is determined based on an intensity distribution in the first surface of the laser light irradiated in the bonding process.

### (Configuration 5)

The method according to any one of configurations 1 to 4, wherein

in the surface treatment process, a processing condition is determined based on at least one of a thermal conductivity of the first member, the absorptance of the first surface for the laser light, or a melting temperature of the second member.

### (Configuration 6)

A composite body manufacturing device, the device manufacturing a composite body in which a first member and a second member are bonded, the first member being made of metal, the second member being made of a resin transmissive to a laser light, the device comprising:
a surface treatment part performing a surface treatment processing of a first surface of the first member to change an absorptance for the laser light,
a bonding part bonding the first surface having undergone the surface treatment processing and a second surface of the second member by irradiating the laser light, without scanning, toward the first surface from a surface of the second member at a side opposite to the second surface in a state in which the first surface is caused to contact the second surface,
the first surface including
   a first portion in which an intensity of the laser light irradiated by the bonding part is a first intensity, and
   a second portion in which the intensity of the laser light irradiated by the bonding part is a second intensity, the second intensity being less than the first intensity,
the surface treatment part performing the surface treatment processing so that a second absorptance becomes greater than a first absorptance,
the second absorptance being an absorptance of the second portion for the laser light,
the first absorptance being an absorptance of the first portion for the laser light.

### (Configuration 7)

The device according to configuration 6, wherein

the surface treatment part increases the absorptance of the second portion for the laser light by irradiating a pulsed laser light on the second portion.

### (Configuration 8)

The device according to configuration 6 or 7, wherein

the surface treatment part performs the surface treatment processing so that the absorptance for the laser light continuously increases from the first portion toward the second portion.

### (Configuration 9)

The device according to any one of configurations 6 to 8, wherein

a difference between the first absorptance and the second absorptance is determined based on an intensity distribution in the first surface of the laser light irradiated by the bonding part.

### (Configuration 10)

The device according to any one of configurations 6 to 9, wherein

a processing condition of the surface treatment part is determined based on at least one of a thermal conductivity of the first member, the absorptance of the first surface for the laser light, or a melting temperature of the second member.

### (Configuration 11)

A composite body, comprising:
a first member including a first surface, the first member being made of metal; and
a second member including a second surface, the second member being made of resin,
the first surface and the second surface being bonded,
the first surface including a first region and a second region,
a surface roughness of at least a portion of the second region being greater than a surface roughness of at least a portion of the first region.

### (Configuration 12)

The composite body according to configuration 11, wherein

a surface roughness of the first surface continuously increases from the first region toward the second region.

Thus, according to embodiments, a composite body manufacturing method, a composite body manufacturing device, and a composite body can be provided in which bonding discrepancies can be suppressed even when the intensity of the irradiated laser light is nonuniform in the bonding surface.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions. Embodiments described above can be implemented in combination with each other.

What is claimed is:

1. A composite body manufacturing method for manufacturing a composite body in which a first member and a second member are bonded, the first member being made of metal, the second member being made of a resin transmissive to a laser light, the method comprising:
a surface treatment process of performing a surface treatment processing of a first surface of the first member to change an absorptance for the laser light; and
a bonding process of bonding the first surface having undergone the surface treatment processing and a second surface of the second member by irradiating the laser light, without scanning, toward the first surface from a surface of the second member at a side opposite to the second surface in a state in which the first surface is caused to contact the second surface,
the first surface including
a first portion in which an intensity of the laser light irradiated in the bonding process is a first intensity, and
a second portion in which the intensity of the laser light irradiated in the bonding process is a second intensity, the second intensity being less than the first intensity,
in the surface treatment process, the surface treatment processing being performed so that a second absorptance becomes greater than a first absorptance,
the second absorptance being an absorptance of the second portion for the laser light,
the first absorptance being an absorptance of the first portion for the laser light.

2. The method according to claim 1, wherein
in the surface treatment process, the absorptance of the second portion for the laser light is increased by irradiating a pulsed laser light on the second portion.

3. The method according to claim 1, wherein
in the surface treatment process, the surface treatment processing is performed so that the absorptance for the laser light continuously increases from the first portion toward the second portion.

4. The method according to claim 1, wherein
in the surface treatment process, a difference between the first absorptance and the second absorptance is determined based on an intensity distribution in the first surface of the laser light irradiated in the bonding process.

5. The method according to claim 1, wherein
in the surface treatment process, a processing condition is determined based on at least one of a thermal conductivity of the first member, the absorptance of the first surface for the laser light, or a melting temperature of the second member.

6. A composite body manufacturing device, the device manufacturing a composite body in which a first member and a second member are bonded, the first member being made of metal, the second member being made of a resin transmissive to a laser light, the device comprising:
a surface treatment part performing a surface treatment processing of a first surface of the first member to change an absorptance for the laser light,
a bonding part bonding the first surface having undergone the surface treatment processing and a second surface of the second member by irradiating the laser light, without scanning, toward the first surface from a surface of the second member at a side opposite to the second surface in a state in which the first surface is caused to contact the second surface,
the first surface including
a first portion in which an intensity of the laser light irradiated by the bonding part is a first intensity, and
a second portion in which the intensity of the laser light irradiated by the bonding part is a second intensity, the second intensity being less than the first intensity,
the surface treatment part performing the surface treatment processing so that a second absorptance becomes greater than a first absorptance,
the second absorptance being an absorptance of the second portion for the laser light,
the first absorptance being an absorptance of the first portion for the laser light.

7. The device according to claim 6, wherein
the surface treatment part increases the absorptance of the second portion for the laser light by irradiating a pulsed laser light on the second portion.

8. The device according to claim 6, wherein
the surface treatment part performs the surface treatment processing so that the absorptance for the laser light continuously increases from the first portion toward the second portion.

9. The device according to claim 6, wherein
a difference between the first absorptance and the second absorptance is determined based on an intensity distribution in the first surface of the laser light irradiated by the bonding part.

10. The device according to claim 6, wherein
a processing condition of the surface treatment part is determined based on at least one of a thermal conductivity of the first member, the absorptance of the first surface for the laser light, or a melting temperature of the second member.

11. A composite body, comprising:
a first member including a first surface, the first member being made of metal; and
a second member including a second surface, the second member being made of resin,
the first surface and the second surface being bonded,
the first surface including a first region and a second region,
a surface roughness of at least a portion of the second region being greater than a surface roughness of at least a portion of the first region.

12. The composite body according to claim 11, wherein
a surface roughness of the first surface continuously increases from the first region toward the second region.
